(19) United States
(12) Patent Application Publication
(10) Pub. No.: US 2025/0322400 A1
(43) Pub. Date: Oct. 16, 2025

(54) Payment Narrative Generating system

(71) Applicants: Pavel Fort, Westbury, NY (US); Aditya Pai, San Francisco, CA (US); Peter Ghiorse, New York, NY (US)

(72) Inventors: Pavel Fort, Westbury, NY (US); Aditya Pai, San Francisco, CA (US); Peter Ghiorse, New York, NY (US)

(73) Assignee: Capital One Services, LLC, McLean, VA (US)

(21) Appl. No.: 18/633,052

(22) Filed: Apr. 11, 2024

(51) Int. Cl. G06Q 20/40; G06Q 20/38

(52) U.S. Cl. CPC G06Q 20/4016; G06Q 20/389

(57) ABSTRACT

The present disclosure describes a generative artificial intelligence-based solution for generating a narrative associated with a transaction. The generative artificial intelligence described herein acquires one or more data points associated with the transaction. Based on these data points, the generative artificial intelligence may generate one or more narratives for the transaction. The one or more narratives may be provided to a user device for a user's review and/or approval. After a narrative is approved, the narrative may be stored. If the transaction is later contested, the narrative may be provided to user to refresh their recollection about the circumstances regarding the transaction.

### FIELD OF THE INVENTION

Aspects of the disclosure generally relate to generative artificial intelligence and, more specifically, generative artificial intelligence for creating narratives associated with transactions.

### BACKGROUND OF THE INVENTION

The growing use of card-based payments (e.g., credit card, debit card, digital wallets, mobile payments, bank transfers, digital currencies, etc.) has led to an increase in online transactions. With a high frequency of online transactions, many customers (e.g., cardholders, clients, users, etc.) find it difficult to recall a past purchase. Customers may find it difficult to keep track of the purchase and the details surrounding the purchase. As a result, customers may be inclined to dispute a transaction (e.g., chargebacks), which occurs when a customer files a formal complaint against a purchase. This could lead to an increase in potential false fraud claims to dispute the transaction, fraud investigations and the costs (e.g., service calls, costs and system inefficiencies) associated with processing these disputes.

While customers could take notes about certain purchases, many customers may not take notes due to the time, hassle, and effort required. Moreover, computer systems may not possess automatic access to the information surrounding a customer's purchase or the ability to verify the information surrounding a customer's purchase. As a result, computer systems are unable to determine the rationale behind a customer's purchase or generate the notes that a customer would typically create. Thus, there is a need for an improved computer system that is able to efficiently collect and provide information surrounding a customer's purchase in a user-friendly format.

### SUMMARY OF THE INVENTION

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

Aspects described herein may relate to a generative artificial intelligence (AI) model configured to create (e.g., generate) narratives for transactions. The narratives may help customers recall the rationale and/or reasoning behind purchases. The narratives may also serve as useful tools in minimizing false fraudulent filings by helping customers remember the reasons why they made a purchase. With the advent of artificial intelligence (AI) technology such as generative AI, there is an opportunity to create user-friendly narratives, for both customers and agents, that explain the what, where, how, and/or why around a specific purchase. The present disclosure describes a generative AI-based solution for generating a narrative (e.g., “Payment Story,” “Payment Narrative,” “Transaction Narrative,” “Narrative,” “a first narrative,” “story”) that serves both customers and agents. For the sake of this disclosure, the generative artificial intelligence (AI) model may be used interchangeably with one or more machine learning models. A transaction may be used interchangeably with a payment, and/or a purchase throughout the disclosure.

Further aspects describe a computer-implemented method that sends a request to generate a narrative for the transaction after determining that a first user has completed a transaction. The first user may provide a response to indicate that the first user would like to generate a narrative for the transaction. The method may involve receiving the first user's response and obtaining one or more data points associated with the transaction. Examples of these one or more data points may be at least one of a location of the transaction, a day of the transaction, a time of the transaction, weather conditions at the time of the transaction, a total cost of the transaction, a price of one or more items associated with the transaction, one or more products that were part of the transaction, or a current event at the time of the transaction. The method may involve inputting the one or more data points into a generative AI model trained to generate narratives for each transaction, for example, based on the one or more data points. The method may generate a narrative associated with the transaction. At some point after the narrative has been generated, the computing device may receive an indication of a potentially fraudulent transaction. The narrative associated with the contested transaction (e.g., potentially fraudulent transaction) may be sent to a user device (e.g., first user device, second user device, etc.). Accordingly, the user device may display the narrative associated with the contested transaction and provide a prompt to a user (e.g., a first user, a second user, etc.) to indicate if they would still like to contest the transaction after having reviewed the narrative.

These features, along with many others, are discussed in greater detail below.

### BRIEF DESCRIPTION OF DRAWINGS

The present disclosure is illustrated by way of example and not limited in the accompanying figures in which like reference numerals indicate similar elements and in which:

FIG. 1 shows an example of a system in which one or more features described herein may be implemented;

FIG. 2 shows an example computing device in accordance with one or more aspects of the disclosure;

FIG. 3 shows an example flowchart for generating a narrative associated with a transaction;

FIG. 4 shows an example of one or more data points that may be used to train one or more machine learning models (e.g., generative AI model) to generate narratives;

FIG. 5 shows an example of a plurality of sources of feedback that users may provide for narratives;

FIG. 6 shows an example system for generating a narrative associated with a transaction and sending the narrative to a user device;

FIG. 7 shows an example of prompting a user to generate a narrative upon detecting a purchase;

FIG. 8 shows an example of prompting a user to review the narrative;

FIG. 9 shows an example flowchart for fraud investigation using the generated narratives;

FIG. 10A shows an example of prompting a user to recall a purchase using a saved narrative;

FIG. 10B shows an example of not initiating a fraud investigation based on the approval of the narrative; and

FIG. 10C shows an example of initiating a fraud investigation based on the rejection of the narrative.

### DETAILED DESCRIPTION OF THE INVENTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

The role of the narrative is to provide a story around a specific purchase or transaction that was made, with language and contextual details that explain the purchase thoroughly. Customers often forget the reasons behind their purchases. For example, as the frequency of purchases increase due to the rise and convenience of online commerce, customers may be prone to forgetting the details around every purchase. Purchases made in the past may also be difficult to remember. The further back in time a purchase was made, the harder it typically may be to recall the specifics surrounding that purchase. This may result in the excessive filing of inadvertent fraudulent claims. While customers may make notes about certain purchases, they typically do not due to the time, hassle, and effort required. Moreover, computer systems typically do not have automatic access to the information surrounding a customer's purchase or the ability to verify the information surrounding a customer's purchase. As a result, computer systems are unable to determine the reasons behind a customer's purchase or generate the notes that a customer would typically make. Thus, there is a need for an improved computer system that is able to collect and provide information surrounding a customer's purchase. By providing such information, customers will be able to easily recall their purchases, decrease the amount of false fraudulent claims that are filed, and improve efficiency.

The narrative generator described herein may be a stand-alone component that may either be hosted on a merchant site/app or accessible as a service on demand, called by the merchant site/app. By leveraging a generative AI model that may be trained, or retrained, using several sources of one or more data points, the narrative generator may be able to provide a detailed explanation around a user's purchase. The narrative generator may be activated when a customer is on a merchant checkout page. Upon activation, the narrative generator may consume a plurality of information from the site (e.g., using a document object model (DOM))—including what is being purchased, who the merchant is, and/or who the customer is. The identity of the customer may be determined, for example, by performing a reverse-lookup based on the credit card number, email, and/or phone number provided on the checkout form. The narrative generator may then produce a narrative and post it to a database.

The database may record and make available the narratives generated for each purchase at a customer level. The database may be accessible to users via an application programming interface (API). Primary users may include customer servicing applications and digital consumer experiences (e.g., issue website, mobile app). Additional users may include analysts, researchers, and marketers. Customers and agents feedback loops may be useful with respect to the ongoing learning and training of the generative AI model. Inconsistencies and errors in produced stories, along with successful story descriptions, may be inputs for model training. Examples of the primary feedback loop channels are: in-app or site feedback mechanisms that customers may use to manually lodge a complaint (e.g., “Report a Problem Button”); transcribed customer servicing calls; and/or customer-agent text exchanges.

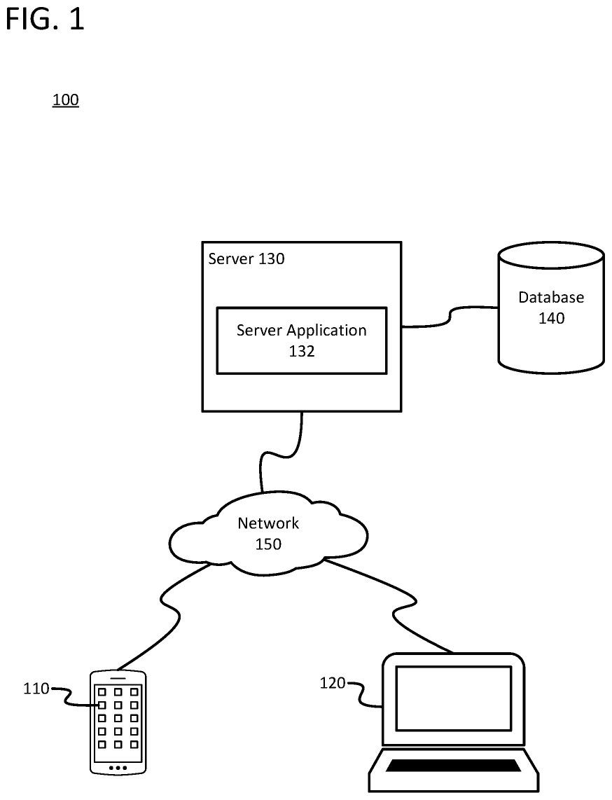

FIG. 1 shows an example of a system 100 that includes a first user device 110, a second user device 120, and a server 130, connected to a database 140, interconnected via network 150.

First user device 110 may be a mobile device, such as a cellular phone, a mobile phone, a smart phone, a tablet, a laptop, or an equivalent thereof. First user device 110 may provide a first user with access to various applications and services. For example, first user device 110 may provide the first user with access to the Internet. Additionally, first user device 110 may provide the first user with one or more applications (“apps”) located thereon. The one or more applications may provide the first user with a plurality of tools and access to a variety of services. In some embodiments, the one or more applications may include a banking application that provides access to the first user's banking information, as well as perform routine banking functions, such as checking the first user's balance, paying bills, transferring money between accounts, withdrawing money from an automated teller machine (ATM), and wire transfers. The banking application may comprise an authentication process to verify (e.g., authenticate) the identity of the first user prior to granting access to the banking information.

Second user device 120 may be a computing device configured to allow a user to execute software for a variety of purposes. Second user device 120 may belong to the first user that accesses first user device 110, or, alternatively, second user device 120 may belong to a second user, different from the first user. Second user device 120 may be a desktop computer, laptop computer, or, alternatively, a virtual computer. The software of second user device 120 may include one or more web browsers that provide access to websites on the Internet. These websites may include banking websites that allow the user to access his/her banking information and perform routine banking functions. In some embodiments, second user device 120 may include a banking application that allows the user to access his/her banking information and perform routine banking functions. The banking website and/or the banking application may comprise an authentication component to verify (e.g., authenticate) the identity of the second user prior to granting access to the banking information.

Server 130 may be any server capable of executing server application 132 or banking application 132. Additionally, server 130 may be communicatively coupled to database 140. In this regard, server 130 may be a stand-alone server, a corporate server, or a server located in a server farm or cloud-computer environment. According to some examples, server 130 may be a virtual server hosted on hardware capable of supporting a plurality of virtual servers.

Banking application 132 may be server-based software configured to provide users with access to their account information and perform routing banking functions. In some embodiments, banking application 132 may be the server-based software that corresponds to the client-based software executing on first user device 110 and second user device 120. Additionally, or alternatively, banking application 132 may provide users access to their account information through a website accessed by first user device 110 or second user device 120 via network 150. The banking application 132 may comprise an authentication module to verify users before granting access to their banking information. Additionally or alternatively, banking application 132 may comprise an automated customer service solution, such as a chatbot or an automated answering service. Additionally, or alternatively, banking application 132 may comprise a narrative generator that may use a generative AI model to generate narratives.

Database 140 may be configured to store information on behalf of the banking application 132. The information may include, but is not limited to, personal information, account information, and user-preferences. Personal information may include a user's name, address, phone number (i.e., mobile number, home number, business number), social security number, username, password, employment information, family information, and any other information that may be used to identify the first user. Account information may include account balances, bill pay information, direct deposit information, wire transfer information, statements, and the like. User-preferences may define how users receive notifications and alerts, spending notifications, and the like. Additionally or alternatively, database 140 may store a plurality of multi-party dialogues, including, for examples, recorded conversations between a customer and a service agent, transcribed conversations, interactions between a customer and a chatbot, etc. Database 140 may include, but are not limited to relational databases, hierarchical databases, distributed databases, in-memory databases, flat file databases, XML databases, NoSQL databases, graph databases, and/or a combination thereof.

Network 150 may include any type of network. In this regard, network 150 may include the Internet, a local area network (LAN), a wide area network (WAN), a wireless telecommunications network, and/or any other communication network or combination thereof. It will be appreciated that the network connections shown are illustrative and any means of establishing a communications link between the computers may be used. The existence of any of various network protocols such as TCP/IP, Ethernet, FTP, HTTP and the like, and of various wireless communication technologies such as GSM, CDMA, WiFi, and LTE, is presumed, and the various computing devices described herein may be configured to communicate using any of these network protocols or technologies. The data transferred to and from various computing devices in system 100 may include secure and sensitive data, such as confidential documents, customer personally identifiable information, and account data. Therefore, it may be desirable to protect transmissions of such data using secure network protocols and encryption, and/or to protect the integrity of the data when stored on the various computing devices. For example, a file-based integration scheme or a service-based integration scheme may be utilized for transmitting data between the various computing devices. Data may be transmitted using various network communication protocols. Secure data transmission protocols and/or encryption may be used in file transfers to protect the integrity of the data, for example, File Transfer Protocol (FTP), Secure File Transfer Protocol (SFTP), and/or Pretty Good Privacy (PGP) encryption. In many embodiments, one or more web services may be implemented within the various computing devices. Web services may be accessed by authorized external devices and users to support input, extraction, and manipulation of data between the various computing devices in the system 100. Web services built to support a personalized display system may be cross-domain and/or cross-platform, and may be built for enterprise use. Data may be transmitted using the Secure Sockets Layer (SSL) or Transport Layer Security (TLS) protocol to provide secure connections between the computing devices. Web services may be implemented using the WS-Security standard, providing for secure SOAP messages using XML encryption. Specialized hardware may be used to provide secure web services. For example, secure network appliances may include built-in features such as hardware-accelerated SSL and HTTPS, WS-Security, and/or firewalls. Such specialized hardware may be installed and configured in system 100 in front of one or more computing devices such that any external devices may communicate directly with the specialized hardware.

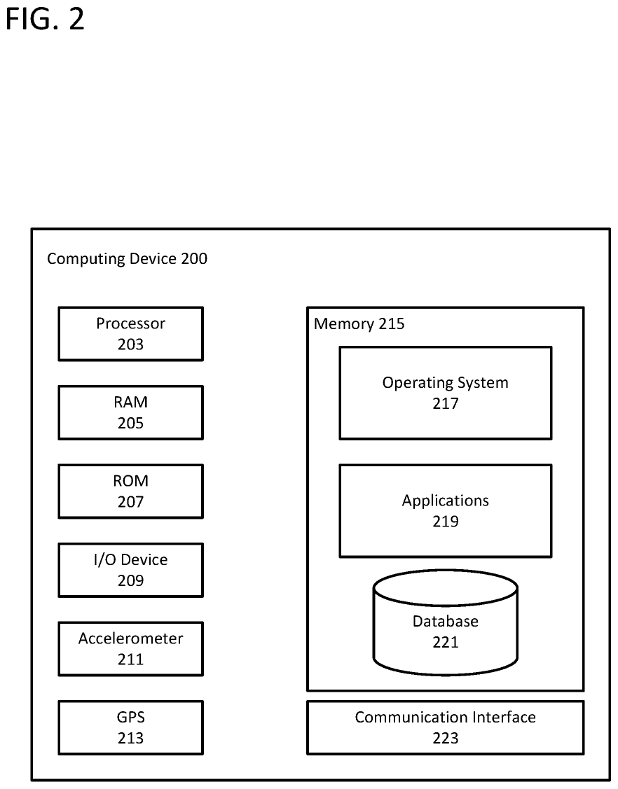

Any of the devices and systems described herein may be implemented, in whole or in part, using one or more computing devices described with respect to FIG. 2. Turning now to FIG. 2, a computing device 200 that may be used with one or more of the computational systems is described. The computing device 200 may comprise a processor 203 for controlling overall operation of the computing device 200 and its associated components, including RAM 205, ROM 207, input/output device 209, accelerometer 211, global-position system antenna 213, memory 215, and/or communication interface 223. A bus 202 may interconnect processor(s) 203, RAM 205, ROM 207, memory 215, I/O device 209, accelerometer 211, global-position system receiver/antenna 213, memory 215, and/or communication interface 223. Computing device 200 may represent, be incorporated in, and/or comprise various devices such as a desktop computer, a computer server, a gateway, a mobile device, such as a laptop computer, a tablet computer, a smart phone, any other types of mobile computing devices, and the like, and/or any other type of data processing device.

Input/output (I/O) device 209 may comprise a microphone, keypad, touch screen, and/or stylus through which a user of the computing device 200 may provide input, and may also comprise one or more speakers for providing audio output and a video display device for providing textual, audiovisual, and/or graphical output. Software may be stored within memory 215 to provide instructions to processor 203 allowing computing device 200 to perform various actions. For example, memory 215 may store software used by the computing device 200, such as an operating system 217, application programs 219, and/or an associated internal database 221. The various hardware memory units in memory 215 may comprise volatile and nonvolatile, removable and non-removable media implemented in any method or technology for storage of information such as computer-readable instructions, data structures, program modules, or other data. Memory 215 may comprise one or more physical persistent memory devices and/or one or more non-persistent memory devices. Memory 215 may comprise random access memory (RAM) 205, read only memory (ROM) 207, electronically erasable programmable read only memory (EEPROM), flash memory or other memory technology, optical disk storage, magnetic cassettes, magnetic tape, magnetic disk storage or other magnetic storage devices, or any other medium that may be used to store the desired information and that may be accessed by processor 203.

Accelerometer 211 may be a sensor configured to measure accelerating forces of computing device 200. Accelerometer 211 may be an electromechanical device. Accelerometer may be used to measure the tilting motion and/or orientation computing device 200, movement of computing device 200, and/or vibrations of computing device 200. The acceleration forces may be transmitted to the processor to process the acceleration forces and determine the state of computing device 200.

GPS receiver/antenna 213 may be configured to receive one or more signals from one or more global positioning satellites to determine a geographic location of computing device 200. The geographic location provided by GPS receiver/antenna 213 may be used for navigation, tracking, and positioning applications. In this regard, the geographic may also include places and routes frequented by the first user.

Communication interface 223 may comprise one or more transceivers, digital signal processors, and/or additional circuitry and software, protocol stack, and/or network stack for communicating via any network, wired or wireless, using any protocol as described herein.

Processor 203 may comprise a single central processing unit (CPU), which may be a single-core or multi-core processor, or may comprise multiple CPUs. Processor(s) 203 and associated components may allow the computing device 200 to execute a series of computer-readable instructions (e.g., instructions stored in RAM 205, ROM 207, memory 215, and/or other memory of computing device 200, and/or in other memory) to perform some or all of the processes described herein. Although not shown in FIG. 2, various elements within memory 215 or other components in computing device 200, may comprise one or more caches, for example, CPU caches used by the processor 203, page caches used by the operating system 217, disk caches of a hard drive, and/or database caches used to cache content from database 221. A CPU cache may be used by one or more processors 203 to reduce memory latency and access time. A processor 203 may retrieve data from or write data to the CPU cache rather than reading/writing to memory 215, which may improve the speed of these operations. In some examples, a database cache may be created in which certain data from a database 221 is cached in a separate smaller database in a memory separate from the database, such as in RAM 205 or on a separate computing device. For example, in a multi-tiered application, a database cache on an application server may reduce data retrieval and data manipulation time by not needing to communicate over a network with a back-end database server. These types of caches and others may provide potential advantages in certain implementations of devices, systems, and methods described herein, such as faster response times and less dependence on network conditions when transmitting and receiving data.

Although various components of computing device 200 are described separately, functionality of the various components may be combined and/or performed by a single component and/or multiple computing devices in communication without departing from the disclosure.

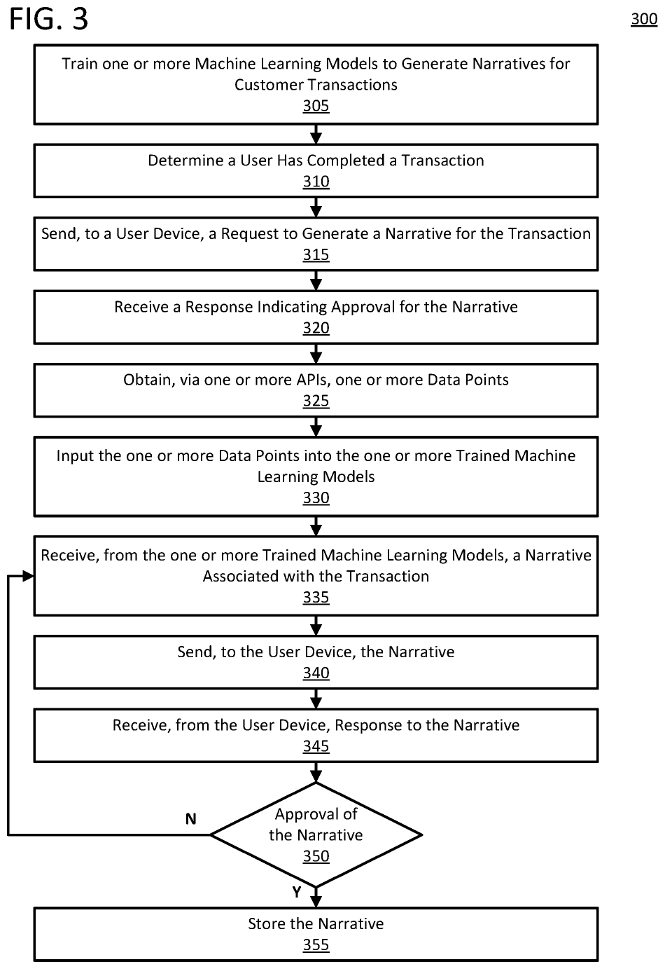

The role of the payment narrative generator may be to create a narrative (e.g., story) around a specific purchase that was made (e.g., transaction, purchase, etc.), with language and contextual details that explain the purchase thoroughly. FIG. 3 shows a flow chart of a process for generating a narrative associated with a transaction according to one or more aspects of the disclosure. Some or all of the steps of process 300 may be performed using one or more computing devices as described herein, including, for example, the first user device 110, the second user device 120, the server 130, the computing device 200, or any combination thereof.

In step 305, a computing device may train one or more machine learning models to generate narratives for transactions. The one or more machine learning models may comprise a generative AI model or a large language model (LLM). The generative AI model may be a publicly-available generative AI model, such as ChatGPT, Bard, M365 Copilot, Scribe, Jasper, etc. Additionally, or alternatively, the one or more machine learning models may be used interchangeably with a generative AI model. The generative AI model may be trained to generate narratives for transactions, for example, based on a plurality of information, such as personal, business, and/or environmental information. The generative AI model may be trained using supervised learning, unsupervised learning, back propagation, transfer learning, stochastic gradient descent, learning rate decay, dropout, max pooling, batch normalization, long short-term memory, skip-gram, or any equivalent deep learning technique. The one or more data points used to train the generative AI model may be further discussed in step 325. The one or more data points may be used interchangeably with data points, dataset, plurality of data points, etc. Examples of one or more data points used to train the generative AI model may include at least one of: a location of the transaction, a day of the transaction, price of items associated with the transaction, weather conditions at the time of the transaction, a total cost of the transaction, products that were part of the transaction, current event at the time of the transaction customer demographics, customer previous payments, servicing agent transcripts, merchant and business information, and story feedback from customer and agents. Once the one or more machine learning algorithms are trained to generate narratives associated with transactions, the one or more machine learning algorithms may be deployed, for example, as part of a mobile application, a browser plug-in, an on-demand service, etc.

In step 310, the computing device may determine that a user completed a transaction. The computing device may determine that that the user completed the transaction, for example, by detecting one or more elements on a webpage indicating that the user may be performing (e.g., conducting) the transaction. The computing device may detect the one or more elements of the webpage using a document object model (DOM). For example, the computing device may detect that the user may be on a merchant checkout page. In another example, the computing device may execute this step through a web browser extension or a mobile app. Additionally, or alternatively, the computing device may be associated with a financial institution. In this regard, the computing device may determine that the user completed the transaction, for example, by detecting an approval of the transaction from the financial institution. In further examples, the computing device may determine that the user completed the transaction via a direct data share from a merchant.

In step 315, the computing device may send a request to generate a narrative for the transaction, for example, based on a determination that the user is conducting and/or completed the transaction. The computing device may send the request to, for example, a user device. This request may be an electronic communication, such as a call to action (CTA) or a user experience (UX) button displayed on the merchant website or a checkout page. Additionally, or alternatively, the request may comprise a push notification sent via a mobile application, a text notification sent to the user's mobile device, or an email sent to a user's email address. The request may inquire whether the user would like to generate a narrative for the transaction.

In step 320, the computing device may receive an indication that the user would like to generate a narrative for the transaction, for example, in response to the request. The user may have approved the request to generate a narrative by selecting the appropriate button associated with generating a narrative. Additionally, or alternatively, the user device may have provided a default response or a predefined response to approve the request to generate a narrative. Additionally, or alternatively, the user may have declined the request to generate a narrative. If the user declined the request to generate the narrative, processing may end until the user conducts another transaction.

Additionally, or alternatively, the computing device may receive a default response (e.g., predefined response, automatic response, etc.) to generate a narrative for the transaction. Computing device may comprise a server for a financial institution that accesses a user's transaction history and generates narratives for all or a subset of transaction. After the computing device determines that a transaction (e.g., purchase, payment, etc.) may have been completed, the payment story generator may proceed to automatically generate a narrative for the transaction. The computing device may not need an affirmative user response in order to generate a narrative.

In step 325, the computing device may obtain one or more data points associated with the transaction. The one or more data points may be obtained via one or more application programming interfaces (APIs). Additionally or alternatively, the one or more data points may be obtained using a document object model (DOM). In this regard, the computing device may detect the one or more elements of the webpage, for example, using the DOM. The one or more data points may comprise at least one of: a location of the transaction; a day of the transaction; a time of the transaction; weather conditions at the time of the transaction; a total cost of the transaction; a price of one or more items associated with the transaction; one or more products that were part of the transaction; or a current event at the time of the transaction. The one or more data points may be helpful sources of information that may be used to generate a thorough and detailed story surrounding a user's purchase. For example, the one or more machine learning models may receive one or more data points indicating that a user shopped at a particular location at a certain time of day. Over time, the one or more machine learning models may be trained, or retrained, based on the one or more data points, for example, to recognize patterns in the user's behavior. For example, the one or more machine learning models may recognize (e.g., identify that the user typically gets gas and a snack at Gas Station X around 6:00 PM after work on Tuesdays). By utilizing the one or more machine learning models, narratives may be generated more efficiently and accurately over time. In another example, the one or more machine learning models may be able to use weather conditions at the time of the transaction to provide additional context to the narrative as further rationale behind the user's purchase. For example, the weather may have been cold and rainy. The narrative may indicate that the user bought an umbrella at a convenience store located near the user's workplace because it was raining that day. The user would be more likely to remember the day the user bought an umbrella because it was rain and she knew she would get soaked walking home from work without one. The one or more data points mentioned above serve as examples and do not represent the full set of data or an exhaustive list of one or more data points used to train the one or more machine learning models. Additionally, or alternatively, the computing device may use any or none of the one or more data points to generate the narrative.

In step 330, the computing device may input the one or more data points into a generative AI model trained to generate narratives. The one or more data points may be cleaned (e.g., scrubbed) and/or preprocessed to remove inconsistencies and/or mitigate any missing values to ensure the data may be suitable for generating narratives. Additionally, or alternatively, the computing device may tokenize the one or more data points, for example, prior to inputting the one or more data points into the generative AI model. In another example, the computing device may encrypt, mask, or use another process of securing the one or more data points, especially when the one or more data points related to user information and/or personally identifiable information (PII). Utilizing data security processes may improve the security of the collected one or more data points, increase the efficiency in managing one or more data points, and minimize the impact of any potential data breach. Sensitive data may proactively be stored separately. As a result, residual costs may also decrease.

In step 335, the computing device may receive, from the generative AI model and based on the one or more data points, a first narrative associated with the transaction. The first narrative may be displayed in a user-friendly manner (e.g., mobile compatibility, screen-readers, error messages, contrasting color scheme, etc.). The first narrative may provide context around the user's transaction or purchase to explain the what, where, how, and/or why around the transaction. An illustrative example of the first narrative may be: “On Tuesday, Dec. 5, 2023, Mary Smith purchased a red wool coat from via a mobile app on her mobile device while possibly commuting to work in Chicago given her location was tracked along the L train path to the downtown station. This coat had been trending on one or more social media sites and, given the temperature had dropped precipitously in the Great lakes region over the past few days, it was a prudent purchase.” This illustrative example of the first narrative showcases that the generative AI model obtained a plurality of data points, such as the date, the user's name, the item that was purchased, the location of the user at the time of the purchase, the merchant name, the model of the user's device used to perform the purchase, the current event at the time of the purchase, the current and recent weather, etc.

In step 340, the computing device may send the user the first narrative to a user device associated with the first user. The first user's device may comprise a mobile device, a smart phone, a laptop, a tablet, etc. The first narrative may be sent (e.g., transmitted) to the user device such that the user may be able to access and review the narrative on the user's device. The first narrative may be sent via an electronic communication, such as a text message, a push notification, an email, and the like. The electronic communication may include a prompt for the first user to approve or reject the narrative upon the user's review. Additionally, or alternatively, the electronic communication may allow the user to edit the first narrative, for example, prior to approving the first narrative. Additionally, or alternatively, the first narrative may be presented (e.g., displayed) in an interactive manner such that the user may be able to scroll through the first narrative and/or edit the first narrative. The user may also incorporate additional details associated with the transaction to help the user recall the transaction in the future. Additionally, or alternatively, the first narrative may be transmitted to engage the user and/or recruit the user's participation by gamifying the process. The computing device may use a gamification technique by inserting game mechanics into the transmission of the first narrative and the user experience (UX) design of the first narrative, such that the user may be more motivated to interact with the first narrative. By providing a stimulating and user-friendly means for the user to interact with the first narrative, the user may be more likely to provide accurate feedback and/or updated training data for the one or more machine learning models to learn from.

In step 345, the computing device may receive the user a response to the first narrative from the user device. The response may include an approval of the first narrative, an approval with edits to the first narrative, or a rejection of the first narrative. The user may consider a plurality of factors to review (e.g., approve, reject, validate, edit, etc.) For example, the user may approve or reject the first narrative with respect to the accuracy of the information presented in the first narrative. The first narrative may be one hundred percent accurate, which may compel the user to approve the first narrative. Alternatively, the first narrative may be mostly accurate with a few minor inaccurate details. Depending on the user, the user may approve the narrative without editing. On the other hand, the user may approve the first narrative with edits. For another user, the few minor inaccurate details may compel user to reject the first narrative. In some embodiments, the computing device may be able to differentiate between these different user responses, for example, by using a threshold score to assess the user's behavior over time and provide adequate feedback data to the one or more machine learning models. In another example, the user may reject the first narrative, for example, if the user was not the one who completed the transaction (e.g., purchase, payment, etc.). This example scenario may be representative of a fraudulent transaction, such as an unknown third party who has stolen the user's credit card information to make unauthorized purchases. Additionally, or alternatively, the user may be provided with a different set of interactive options to indicate whether the first narrative is approved or rejected. After transmitting the narrative, the user may be prompted to respond with an immediate dispute of the fraudulent purchase before the purchase is further processed by the merchant or to freeze the credit card account. By performing these steps in real time, the problem may be resolved instantly and the chances of further compromises may be minimized. This would allow for the costs associated with processing purchase disputes to be decreased. Additionally, or alternatively, the computing device may automatically initiate a dispute with the merchant or with the credit card company. The computing device may automatically initiate a request to freeze the credit card. The computing device may perform any variation of steps to further secure the user's information associated with the fraudulent purchase.

In step 350, the computing device may determine whether the response indicates an approval of the first narrative, an approval of the first narrative with edits, or a rejection of the first narrative. If the response is a rejection (i.e., “N”), the process may go back to step 335. A new narrative may be generated at step 335 and the approval process may repeat. If the response includes an approval, or an approval with edits (i.e., “Y”), the narrative may be stored, in step 355. Additionally, or alternatively, the response may consist of varying results depending on the prompts provided to the user device, as discussed in step 345.

In step 355, the computing device may store the narrative, for example, based on an approval or an approval with edits. The narrative may be stored in a database, such as database 140 discussed above or payment story database 625 discussed below. The approval response or the fact that the narrative was approved with edits may also be stored. Storing this information may serve as additional training data for the generative AI model. Additionally, or alternatively, the stored narratives may be accessed through the database to help a user recall a purchase at a later point in time (e.g., future, after the fact). For example, the user may notice a charge on the credit card statement a month after the date of the transaction. The user may attempt to dispute the charge and file a claim to assert that the transaction was fraudulent or unauthorized. The computing device may present a narrative associated with the transaction to help the user recall the purchase, prior to proceeding with the fraud investigation.

While the method above describes generating narratives in real-time, or near real-time, after a customer has conducted a transaction, it will be appreciated that the narratives may be generated dynamically for past (e.g., prior, earlier) transactions. For example, the one or more APIs may obtain information from a variety of data sources to better understand the reasoning for the transaction. One or more data points may be inputted (e.g., provided) to the one or more machine learning models. The one or more machine learning models may then generate one or more narratives for each of the past transactions. In some instances, the system may request user approval for each of the narratives for the previous transactions using the techniques described above.

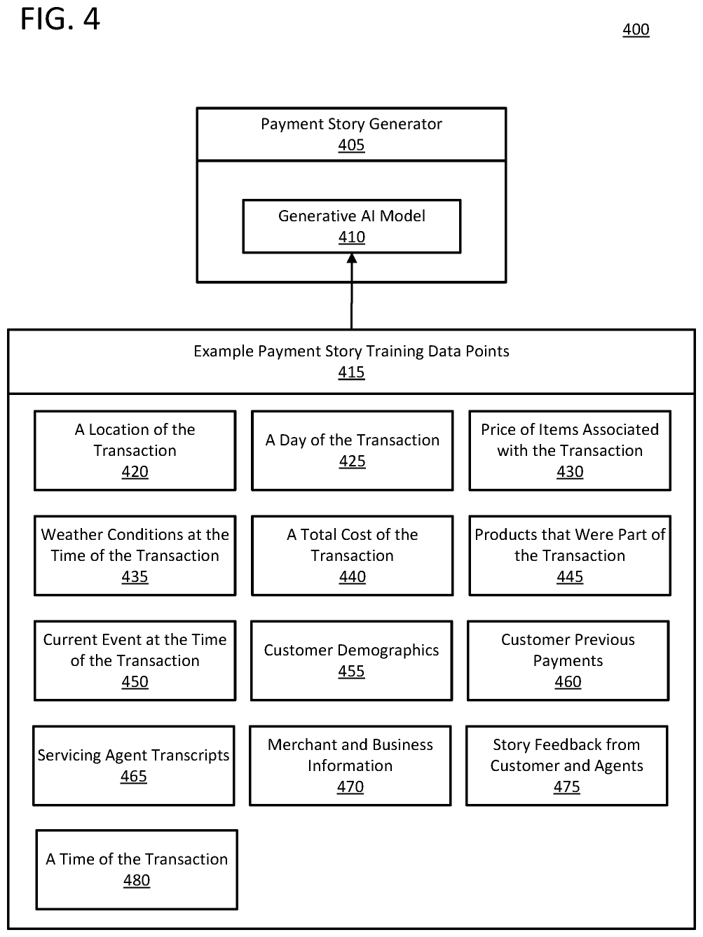

The one or more machine learning models discussed in process 300 (e.g., generative AI model 410) may collect a plurality of training data points (e.g., one or more data points) related to a transaction (e.g., purchase, payment, etc.) to generate an accurate and descriptive narrative associated with the transaction. FIG. 4 shows an example of one or more data points that may be used to train one or more machine learning models to generate narratives. The generative AI model 410 may be integral (e.g., part of) the payment story generator 405. The generative AI model 410 may comprise the one or more machine learning models trained in step 305, above. The example payment story training data points 415 illustrate the one or more data points that the generative AI model 410 may use to generate a narrative. The example payment story training data points 415 may comprise at least one of a location of the transaction 420, a day of the transaction 425, a price of one or more items associated with the transaction 430, weather conditions at the time of the transaction 435, a total cost of the transaction 440, one or more products that were part of the transaction 445, a current event at the time of the transaction 450, customer demographics 455, customer previous payments 460, servicing agent transcripts 465, merchant and business information 470, story feedback from customer and agents 475, and/or a time of the transaction 480. Once the generative AI model 410 generates a narrative associated with the transaction, the computing device may send the narrative from the payment story generator 405 to one or more user devices, as discussed above in process 300. The one or more data points shown in FIG. 4 serve as examples and do not represent the full set of data or an exhaustive list of data points that may be used to train the generative AI model 410. Additionally, or alternatively, the computing device may use any or none of the one or more data points to generate the narrative.

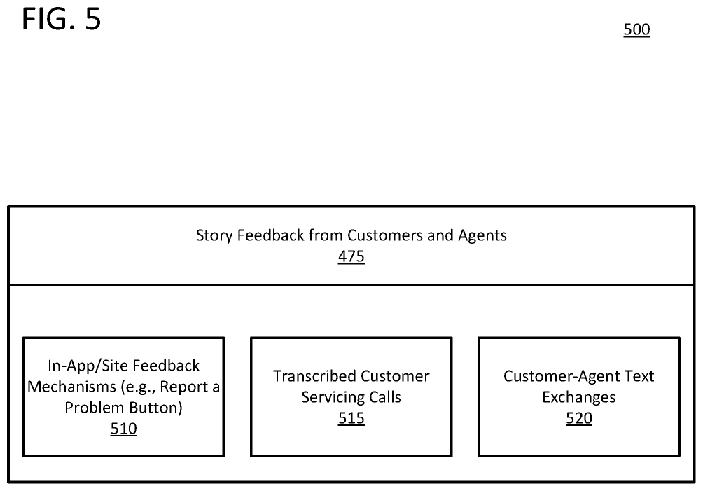

Customer and agent feedback loops may be used to train, or retrain, generative AI model 410. Inconsistencies and/or errors in generated narratives, along with successful story descriptions (e.g., narratives), may be inputted to the generative AI model 410 to train, or retrain, the generative AI model 410. FIG. 5 shows examples of payment story feedback from customers and agents 475, such as, in-app/site feedback mechanisms 510 (e.g., report a problem button), transcribed customer servicing calls 515, and customer-agent text exchanges 520. The examples of payment story feedback from customers and agents 475 may serve as additional data points 415 for the generative AI model 410 (e.g., one or more machine learning models) to generate narratives.

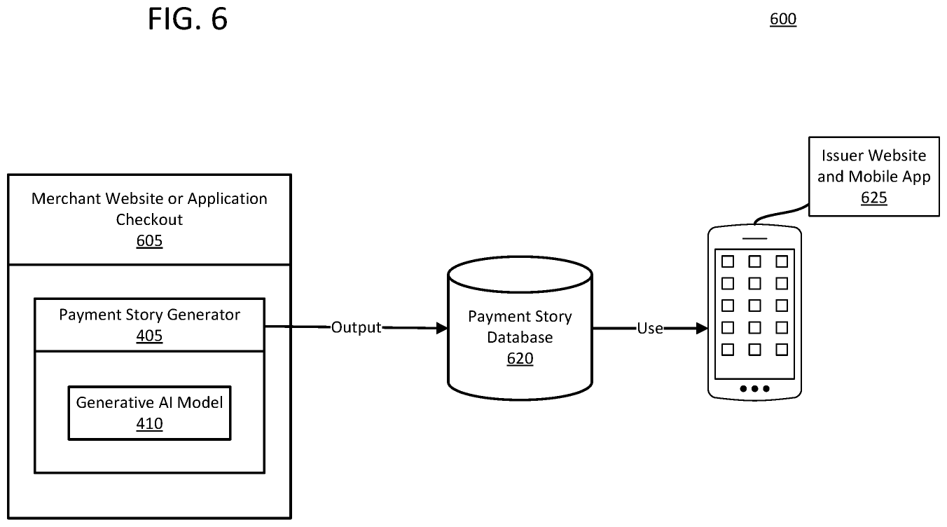

FIG. 6 shows an example system for generating a narrative associated with a transaction (e.g., purchase, payment, etc.) and sending the narrative to a user device. The payment story generator 405 may be a stand-alone component that may be hosted on a merchant website 605. Additionally, or alternatively, the payment story generator 405 may be accessible as a service on demand called by a merchant website 605. In a further example, payment story generator 405 may be hosted on an app on mobile device. The generative AI model 410 (e.g., one or more machine learning models) may collect one or more data points from merchant website 605 to generate a narrative associated with a transaction. A user transaction may be detected from the merchant website 605. A computing device may send the generated narrative from the payment story generator 405 as output to payment story database 620. The computing device may be a server for a financial institution that accesses a user's transaction history and generates narratives for all or a subset of transactions. Payment story database 620 may be similar to, or the same as, database 140, described above. The computing device may access the narrative from the payment story database 620 to be used by the issuer website or mobile application 625. The user device may display a prompt for the user to validate, reject, or edit the narrative. Additionally, or alternatively, the computing device may send a narrative to the user device when the user is disputing a transaction in order to help the user recall the purchase.

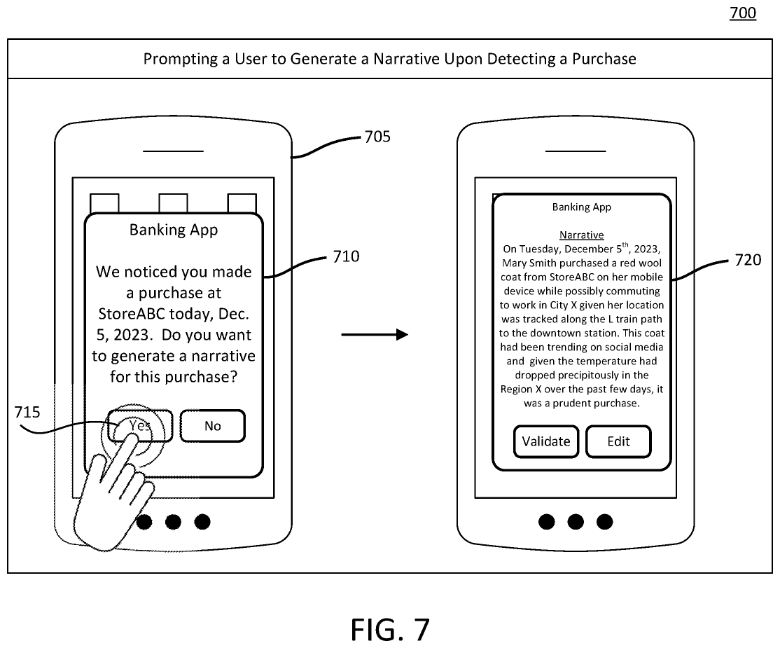

The computing device may determine that a user has completed a transaction, for example, based on the information collected from a mobile application executing on a user device or from a website. The user may have the choice to generate a narrative associated with a transaction (e.g., purchase, payment, etc.). FIG. 7 shows an example of prompting a user to select the option to generate a narrative upon detecting a transaction. Process 700 illustrates an example of one or more user interfaces for generating a narrative associated with a transaction. The one or more user interfaces may be displayed, for example, in association with step 315, discussed above. In this regard, a computing device may send a request 710 to user device 705. The request 710 may inquire whether the user would like to generate a narrative for a transaction. The request 710 may be sent to a user device 705 (e.g., a mobile device, smart phone, tablet, laptop, etc.) through a mobile application on user device 705. In some examples, the mobile application may comprise a banking application.

The user may make an affirmative selection 715 (i.e., “Yes”) to generate a narrative for the purchase. Additionally, or alternatively, instead of selecting “Yes” 715 to generate a narrative for the purchase, the user may select “No.” In this case, a narrative for the purchase may not be generated and the process may end.

Following the affirmative selection 715, the computing device may send a narrative 720 associated with the transaction as shown. The user device may display the narrative to the user. For example, narrative 720 states, “On Tuesday, Dec. 5, 2023, Mary Smith purchased a red wool coat from StoreABC on her mobile device while possibly commuting to work in City X given her location was tracked along the L train path to the downtown station. This coat had been trending on social media and given the temperature had dropped precipitously in the Region X over the past few days, it was a prudent purchase.” Narrative 720 is an example of a narrative that may be generated by the one or more machine learning models (e.g., generative AI model) described herein. Additionally, or alternatively, the request 710 may be displayed by the merchant website on the checkout page or the confirmation page for example, once the user has completed the transaction. Additionally, or alternatively, the user may have opted to automatically generate a narrative for any purchases that the user may have made based on a plurality of predetermined factors, such that the user may not be required to provide affirmative selection 715 to generate narrative 720. For example, the user may indicate that narratives may be generated for any purchases made with a specific credit card or bank account, within a period of time, or from a specific store. The user may be able to make a variety of customizations to the narrative generation process.

Once the narrative has been displayed on the user device, the process may end. Additionally, or alternatively, the user device may display a prompt for the user to review the narrative. The user device may allow the user to select the option to validate the narrative or to edit the narrative.

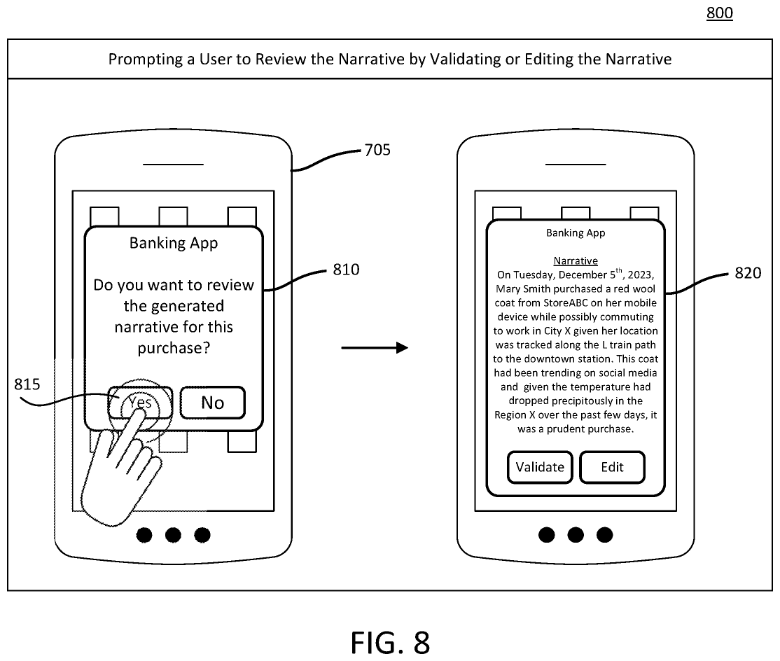

A user may be presented with the opportunity to review and/or edit narrative before the narrative is stored. FIG. 8 shows an example of one or more interfaces prompting a user to review the narrative after the narrative has been generated. The user may have selected the option to generate a narrative (e.g., 715). Additionally, or alternatively, the narrative may be generated automatically. The one or more user interfaces shown in FIG. 8 may be displayed, for example, in association with steps 340-350, discussed above. The computing device may generate the narrative and prompt 810 the user to review the narrative. The user may provide an affirmative selection 815 (e.g., “Yes”) to indicate that the user would like to review the generated narrative. The narrative prompt 820 provides the option for a user to “Validate” or “Edit” the narrative.

The “Validate” selection may indicate that the generated narrative provides accurate details surrounding the user's purchase without any errors or inconsistencies. Additionally, or alternatively, the user may select “Validate” despite a few discrepancies in the narrative. This could be due to the user's error, lack of awareness or mistaken memory. This may also occur when the narrative includes sufficient details such that the narrative may be mostly accurate with the exception of a few minor details, which the user does not care to correct. The generative AI model (e.g., one or more machine learning models) may be retrained based on the feedback response (e.g., one or more data points). Over time, the generative AI model may recognize a threshold score for the user's feedback accuracy.

The “Edit” selection may indicate that the generated narrative has a few errors that the user may opt to correct. For example, the user may have selected to buy this coat without realizing that the coat had been trending. The user may edit the narrative to indicate that the user was unaware that the coat was trending on social media. In another example, the user may have selected to buy this coat as a gift for her sister. The user may edit the narrative to indicate that the user has bought the coat as a gift for her sister. The user generated edits may provide feedback to retrain the generative AI model. Furthermore, the generated edits may serve as a memory enhancer or memory aid to help the user recall the purchase more efficiently in the future.

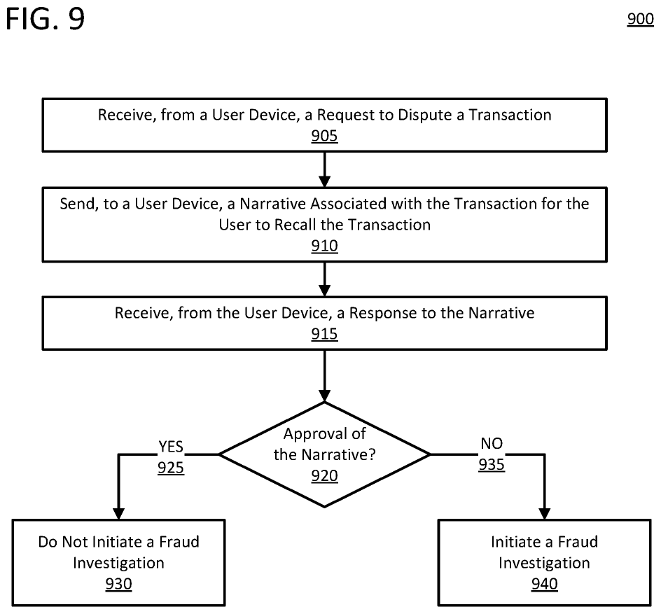

The generated narrative may serve multiple purposes in a number of different situations. In the case that the user would like to dispute a transaction due to potential fraud, the generated narrative could help by aiding the user in recalling the purchase details. FIG. 9 shows an example process 900 investigating fraud using the generated narratives.

At step 905, the computing device may receive a request to dispute a transaction (e.g., purchase, payment, etc.) from a user device. This situation may occur when the user notices a charge that the user does not recall while browsing the user's credit card statement. Credit card statements are typically released on a monthly basis. For many user's, the details around a purchase made 28 days ago may be difficult to remember. Sometimes, the transaction on a credit card statement lists an unrecognizable merchant name. For example, the charges may appear under an alternate business name or list the company's headquarters location rather than the purchase location. Vendor naming conventions that aim for clarity can also prove challenging. Per Visa's Merchant Data Standards, the name must convey both the name most prominently displayed by the merchant and the merchant's “Doing Business As” (DBA) name. While the name may have made sense at the time of the purchase, the bill 28 days later could list a company name with no indication of the expected merchant name. Furthermore, transaction data may often times be limited to 25 characters. This character limit may be sufficient for most merchants, but not for others. This may lead to unrecognizable charges and confusion amongst users. As a result, a user may opt to dispute a charge with the user's bank. The computing device may determine that the user is requesting to dispute a charge due to a fraudulent or unauthorized purchase.

At step 910, the computing device may send a narrative associated with the transaction to a user device. The narrative may help the user to recall the transaction. Prior to initiating a fraud investigation, the computing device may send the narrative to the user to help the user recall the details around the transaction. By doing so, the bank may be able to potentially minimize the filing of false fraud claims. The computing device may send the narrative that was generated by the one or more machine learning models and stored in the payment story database. The narrative may have been approved or edited by the user as described above. Additionally, or alternatively, the narrative may have been generated and stored without the user's approval or edit. Additionally, or alternatively, the narrative may be generated dynamically, at the time of the user's dispute. The one or more machine learning models may use one or more data points associated with the purchase from the time of transaction.

At step 915, the computing device may receive the user a response to the narrative from device. The response may be indicative of whether the user recalls the purchase or does not recall the purchase based on the narrative. The user may provide the response with an affirmative selection on the user device (e.g., smart phone, tablet, laptop, etc.). Additionally, or alternatively, the UX design for requesting a response from the user may vary. For example, a request may not be necessary. Instead, the user may simply choose to continue with disputing the charge and filing a fraudulent claim after reviewing the narrative without providing a response to the narrative.

At decision 920, the user may either provide an approval of the narrative by selecting “Yes” 925, or a rejection of the narrative by selecting “No” 935. An approval of the narrative at decision 920 may indicate that the user has been able to recall the purchase based on the narrative. Every detail of the narrative may or may not be accurate. However, the narrative may be sufficiently correct to help a user remember the purchase. Additionally, or alternatively, the narrative may be a modified version, generated by the one or more machine learning models described herein. The modified version may be based on details that are more likely to help a user remember a purchase. For example, a user may be more likely to remember making a purchase based on a narrative that provides the store name, the item, and the current event surrounding the purchase, than a narrative that provides the exact date, precise time and address of the store. The edits, revisions, and/or feedback may be used to retrain the one or more machine learning models.

At step 930, the user selected to approve the narrative (i.e., “Yes” 925) and the computing device may not initiate a fraud investigation. The approval may indicate that the narrative has successfully aided a user in recalling the purchase. The suspected charge may have been a false fraudulent claim. The generated narrative may have helped the user remember the purchase, as well as prevent an unnecessary charge dispute and fraud investigation. The benefit of decreased filings may be advantageous for financial institutions that seek to improve cost efficiency and time efficiency.

At step 940, the user selected to reject the narrative (i.e., “No” 935) and the computing device may proceed to initiate a fraud investigation. The rejection may be indicative of several scenarios. For example, the narrative may have been accurate, but the user may be unable to remember the purchase. In another example, the narrative may have been accurate and the user was not the one to execute the purchase. Instead, an unauthorized user may have fraudulently executed the purchase. In yet another example, the narrative may have been inaccurate. Due to the inaccuracy, the user may have been unable to recall the purchase. In yet another example, the narrative may have been inaccurate, but regardless of the inaccuracy, the user was not the one to execute the purchase. Instead, an unauthorized user may have fraudulently executed the purchase. There may be various other examples of the rationale behind the rejection. Nevertheless, this narrative has served its purpose as a secondary layer of protection (e.g., defense mechanism) against false fraudulent filings (e.g., unnecessary charge disputes). The bank may proceed to investigate the fraud filing in order to determine the legitimacy of the chargeback request, identify and understand the fraud threats the bank may be facing, as well as determine strategies for prevention. The bank may use this investigation to determine the next steps to address the instances of fraud. This means determining whether fraud has, in fact, occurred, who committed the fraud, how the fraud was committed, and how to defend against further instances of this type of fraud in the future. As a result of the investigation, the bank may act on the case by reimbursing the client, charging the merchant, or pursuing the fraudster to recover losses. In one or more instances, the bank may use the narrative as a resource during the fraud investigation. For example, the narrative may provide insight into the details around the purchase in order to determine who may have committed the fraud or how the fraud was committed. In another example, the bank may speak with the user to receive feedback and rationale regarding the user's rejection of the narrative.

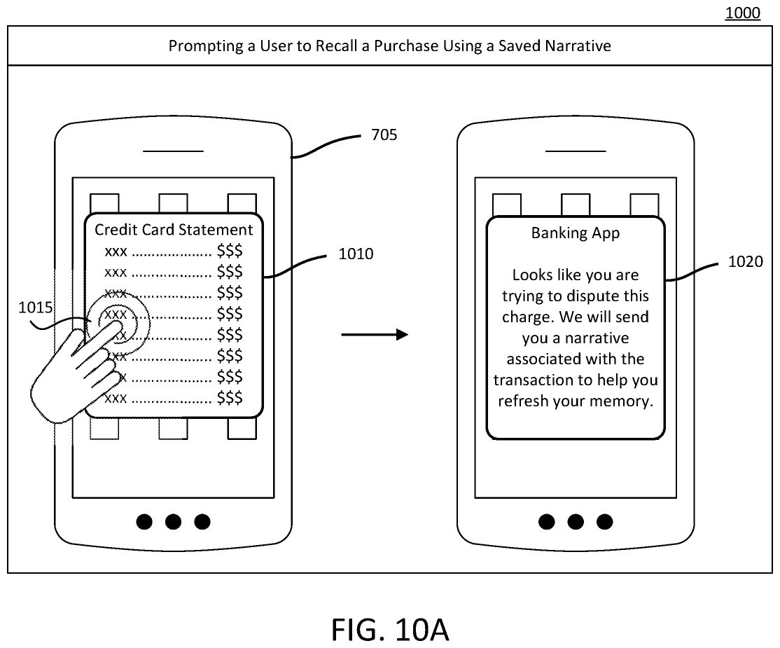

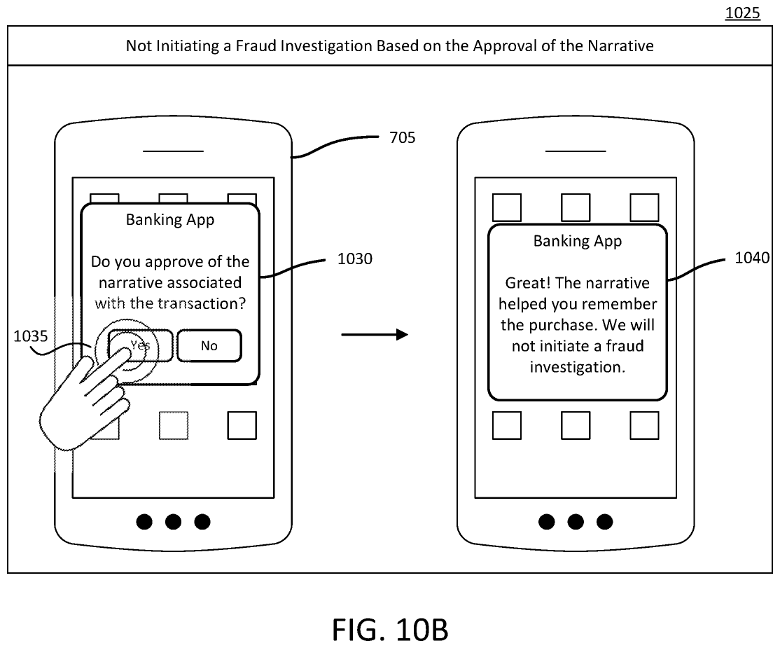

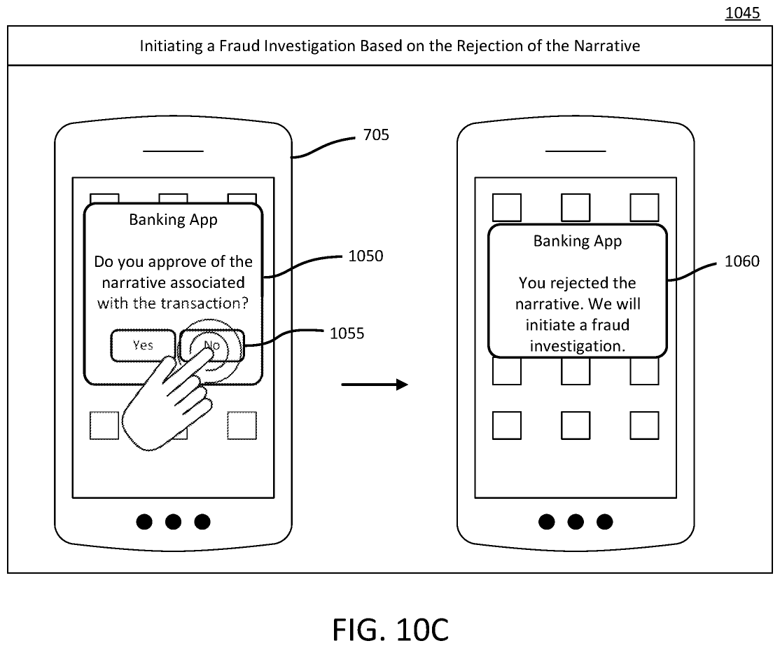

FIG. 10A shows an example of a user interface a user to recall a transaction (e.g., purchase, payment, etc.) using a saved narrative. The user may review the credit card statement 1010 on the user device 705 and notice an unfamiliar charge 1015. The user may opt to dispute an unfamiliar charge 1015 with the bank. As discussed above, credit card statements are typically released on a monthly basis. For many user's, the details around a transaction made in the past may be difficult to remember. The computing device may determine that the user may be requesting to dispute a charge due to a fraudulent or unauthorized purchase. The message 1020 says, “Looks like you are trying to dispute this charge. We will send you a narrative associated with the transaction to help you refresh your memory.” Providing a narrative associated with the chargeback request may serve as a secondary layer of protection (e.g., defense mechanism) against false fraud filings.

FIG. 10B shows an example of user interfaces for not initiating a fraud investigation based on the approval of the narrative. The computing device may provide a message requesting a user indicate whether the user approves of the narrative associated with the transaction 1030. The message may ask, “Do you approve of the narrative associated with the transaction?” 1030. As discussed above, the user response may be indicative of whether the user recalls the purchase or does not recall the transaction (e.g., purchase) based on the narrative. The user may provide the response with an affirmative selection 1035 on the user device 705.

Additionally, or alternatively, the UX design for requesting a response from the user may vary. For example, a request may not be necessary. Instead, the user may simply choose to continue with disputing the charge and filing a fraudulent claim after reviewing the narrative without providing a response to the narrative. The user may provide an approval of the narrative by selecting “Yes” 1035. An approval of the narrative may indicate that the user has been able to recall the purchase based on the narrative. Every detail of the narrative may or may not be accurate. However, the narrative may be sufficiently correct to help a user remember the purchase. The narrative may be the same narrative that the user approved or edited at decision 350.

Additionally, or alternatively, the narrative may be a modified version, generated by the one or more machine learning models (e.g., generative AI model). The modified version may be based on details that are more likely to help a user remember a purchase. For example, a user may be more likely to remember making a purchase based on a narrative that provides the store name, the item, and the current event surrounding the purchase, rather than a narrative that provides the exact date, precise time and address of the store.

As discussed above, the approval may indicate that the narrative has successfully aided a user recall the purchase. The computing device may provide a message 1040 that states, “Great! The narrative helped you remember the purchase. We will not initiate a fraud investigation.” This means that the financial institution may not initiate a fraud investigation. The suspected charge may have been a false fraudulent claim. The generated narrative may have helped the user remember the purchase, as well as prevent an unnecessary charge dispute and fraud investigation. The benefit of decreased filings may be advantageous for financial institutions that seek to improve cost efficiency and time efficiency.

FIG. 10C shows an example of user interfaces for initiating a fraud investigation based on the rejection of the narrative. The computing device may provide a message requesting a user to indicate whether the user approves of the narrative associated with the transaction 1050 (e.g., purchase, payment, etc.). The message may ask, “Do you approve of the narrative associated with the transaction?” 1050. As discussed with respect to step 940, the user's response may be indicative of whether the user recalls the purchase or does not recall the purchase based on the narrative. The user may provide the response with a rejection 1055 on the user device 705 (e.g., smart phone, tablet, laptop). The rejection may be indicative of several scenarios. For example, the narrative may have been accurate, but the user may be unable to remember the purchase. In another example, the narrative may have been accurate and the user was not the one to execute the purchase. Instead, an unauthorized user may have fraudulently executed the purchase. In yet another example, the narrative may have been inaccurate. Due to the inaccuracy, the user may have been unable to recall the purchase. In yet another example, the narrative may have been inaccurate, but regardless of the inaccuracy, the user was not the one to execute the purchase. Instead, an unauthorized user may have fraudulently executed the purchase. There may be various other examples of the rationale behind the rejection. Nevertheless, this narrative has served its purpose as a secondary layer of protection (e.g., defense mechanism) against false fraudulent filings (e.g., unnecessary charge disputes).

The user device may provide a message 1060 that states, “You rejected the narrative. We will initiate a fraud investigation.” The financial institution may proceed to investigate the fraud filing in order to determine the legitimacy of the chargeback request, identify and understand the fraud threats the financial institution may be facing, as well as determine strategies for prevention. The financial institution may use this investigation to determine the next steps to address the instances of fraud. This means determining whether fraud has, in fact, occurred, who committed the fraud, how the fraud was committed, and how to defend against further instances of this type of fraud in the future. As a result of the investigation, the financial institution may act on the case by reimbursing the client, charging the merchant, or pursuing the fraudster to recover losses. In one or more instances, the financial institution may use the narrative as a resource during the fraud investigation. For example, the narrative may provide insight into the details around the purchase in order to determine who may have committed the fraud or how the fraud was committed. In another example, the financial institution may speak with the user to receive feedback and rationale regarding the user's rejection of the narrative.

Using the techniques described above, the present disclosure may relate to generative AI configured to create (e.g., generate) narratives for transactions. Several use case examples, as discussed above, may illustrate the advantages and benefits of generating narratives associated with transactions. Users may benefit from the narratives by serving as an aid to help users recall the details, rationale and/or reasoning behind purchases. The narratives may also benefit financial institutions by serving as useful tools in minimizing false fraudulent filings and helping customers remember the reasons why they made the purchase. The benefit of decreased filings may be advantageous for financial institutions by improving cost efficiency and time efficiency. With the advent of artificial intelligence (AI) technology such as generative AI, there is an opportunity to create user-friendly narratives, for both customers and agents, that explain the what, where, how, and why around a specific purchase. The present disclosure describes a generative AI-based solution for generating a narrative (e.g., “Payment Story,” “Payment Narrative,” “Transaction Narrative,” “Narrative,” “a first narrative”) that serves both customers and agents.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method comprising:
determining, by a computing device, that a user completed a transaction;
sending, based on a determination that the user completed the transaction, a request to generate a narrative for the transaction;
receiving, in response to the request, a response indicating that the user would like to generate a narrative for the transaction;
obtaining, via one or more application programming interfaces, one or more data points associated with the transaction, wherein the one or more data points comprise at least one of: a location of the transaction, a day of the transaction; a time of the transaction, weather conditions at the time of the transaction, a total cost of the transaction, a price of one or more items associated with the transaction, one or more products that were part of the transaction, or a current event at the time of the transaction;
inputting the one or more data points into a generative artificial intelligence model trained to generate narratives for each transaction;
receiving, from the generative artificial intelligence model and based on the one or more data points, a first narrative associated with the transaction;
receiving, by the computing device, an indication of a potentially fraudulent transaction;
sending, to a user device, a second narrative associated with the potentially fraudulent transaction; and
causing, based on the indication of the potentially fraudulent transaction and based on the second narrative, the user device to display a prompt to validate the potentially fraudulent transaction.

2. The method of claim 1, wherein the determining that the user completed the transaction comprises detecting, using a document object model (DOM), one or more elements on a webpage indicating that the user is performing the transaction.

3. The method of claim 1, further comprising:
receiving a confirmation that the potentially fraudulent transaction was fraudulent; and
sending, based on receiving the confirmation, an indication that a fraud investigation will be opened.

4. The method of claim 1, further comprising:
receiving an indication that the potentially fraudulent transaction was not fraudulent; and
sending, to the user device and based on the indication that the potentially fraudulent transaction was not fraudulent, an indication that a fraud investigation will not be opened.

5. The method of claim 1, further comprising verifying, based on performing a reverse-lookup of the user's card number, the user and user information associated with the transaction.

6. The method of claim 1, further comprising training, based on the one or more data points, the generative artificial intelligence model to generate narratives for transactions.

7. The method of claim 1, further comprising dynamically generating narratives for transactions in real-time.

8. The method of claim 1, further comprising retroactively generating narratives for past transactions.

9. The method of claim 1, further comprising tokenizing the one or more data points.

10. A computing device comprising:
one or more processors; and
memory storing instructions that, when executed by the one or more processors, cause the computing device to:
send, based on a determination that a user completed a transaction, a request to generate a narrative for the transaction;
obtain, via one or more application programming interfaces, one or more data points associated with the transaction, wherein the one or more data points comprise at least one of: a location of the transaction, a day of the transaction, a time of the transaction, weather conditions at the time of the transaction, a total cost of the transaction, a price of one or more items associated with the transaction, or one or more products that were part of the transaction;
input the one or more data points into a generative artificial intelligence model;
receive, from the generative artificial intelligence model and based on the one or more data points, a first narrative associated with the transaction;
send, to a user device associated with the user, the first narrative;
receive, from the user device, an approval of the first narrative; and
store, based on the approval, the first narrative in a database.

11. The computing device of claim 10, wherein the instructions, when executed by the one or more processors, cause the computing device to:
train, based on the one or more data points, the generative artificial intelligence model to generate narratives for each transaction.

12. The computing device of claim 10, wherein the instructions, when executed by the one or more processors, cause the computing device to:
receive an indication of a potentially fraudulent transaction;
send, to a user device, a second narrative associated with the potentially fraudulent transaction; and
cause, based on the indication of the potentially fraudulent transaction and based on the second narrative, the user device to display a prompt to validate the potentially fraudulent transaction.

13. The computing device of claim 12, wherein the instructions, when executed by the one or more processors, cause the computing device to:
receive a confirmation that the potentially fraudulent transaction was fraudulent; and
send, based on receiving the confirmation, an indication that a fraud investigation will be opened.

14. The computing device of claim 12, wherein the instructions, when executed by the one or more processors, cause the computing device to:
receive an indication that the potentially fraudulent transaction was not fraudulent; and
send, to the user device and based on the indication that the potentially fraudulent transaction was not fraudulent, an indication that a fraud investigation will not be opened.

15. The computing device of claim 10, wherein the instructions, when executed by the one or more processors, cause the computing device to:
dynamically generate narratives for transactions in real-time; or
retroactively generate narratives for past transactions.

16. A non-transitory computer readable medium comprising instructions that, when executed, cause a computing device to:
send, based on a determination that a user completed a transaction, a request to generate a narrative for the transaction;
obtain, via one or more application programming interfaces, one or more data points associated with the transaction;
input the one or more data points into a generative artificial intelligence model trained to generate narratives for each transaction;
receive, from the generative artificial intelligence model and based on the one or more data points, a first narrative associated with the transaction;
send, to a user device associated with the user, the first narrative;
receive, from the user device, an approval of the first narrative; and
store, and based on the approval, the first narrative in a database.

17. The non-transitory computer readable medium of claim 16, wherein the instructions, when executed, cause the computing device to:
receive an indication of a potentially fraudulent transaction;
send, to a user device, a second narrative associated with the potentially fraudulent transaction; and
cause, based on the indication of the potentially fraudulent transaction and based on the second narrative, the user device to display a prompt to validate the potentially fraudulent transaction.

18. The non-transitory computer readable medium of claim 17, wherein the instructions, when executed by the one or more processors, cause the computing device to:
receive a confirmation that the potentially fraudulent transaction was fraudulent; and
send, based on receiving the confirmation, an indication that a fraud investigation will be opened.

19. The non-transitory computer readable medium of claim 17, wherein the instructions, when executed by the one or more processors, cause the computing device to:
receive an indication that the potentially fraudulent transaction was not fraudulent; and
send, to the user device and based on the indication that the potentially fraudulent transaction was not fraudulent, an indication that a fraud investigation will not be opened.

20. The non-transitory computer readable medium of claim 16, wherein the instructions, when executed, cause the computing device to at least one of:
dynamically generate narratives for transactions in real-time; or
retroactively generate narratives for past transactions.
